(19) United States
(12) Patent Application Publication
(10) Pub. No.: US 2026/0192519 A1
(43) Pub. Date: Jul. 9, 2026

(54) SYSTEM AND METHOD FOR TRANSFER FILM MANAGEMENT IN ADDITIVE MANUFACTURING

(71) Applicant: Supernova Industries Corp., Austin, TX (US)

(72) Inventors: Roger Antunez Francisco, Barcelona (ES); Marta Mico Martinez, Barcelona (ES); Boris Agea Blanco, Barcelona (ES); Vladimir Shumovskiy, Barcelona (ES); Dervla Braem, Barcelona (ES); Manuel Joao Martins Barroeta, Barcelona (ES); Eric Pallares Garcia, Barcelona (ES); Oriol Bel Laveda, Barcelona (ES)

(21) Appl. No.: 19/383,041

(22) Filed: Nov. 7, 2025

Related U.S. Application Data
(60) Provisional application No. 63/718,423, filed on Nov. 8, 2024.

(51) Int. Cl. B29C 64/245; B29C 64/124; B29C 64/393; B33Y 10/00; B33Y 30/00; B33Y 50/02

(52) U.S. Cl. CPC B29C 64/245; B29C 64/124; B29C 64/393; B33Y 10/00; B33Y 30/00; B33Y 50/02

(57) ABSTRACT

An additive manufacturing machine and method of printing therewith. The additive manufacturing machine includes a process chamber, a first platform mounted on top of the process chamber, a first rail mounted to the first platform and a second rail mounted to the first platform parallel to the first rail. A first carriage is movably mounted on the first rail and the second rail and a first retention mount is connected to the first carriage. A second carriage is movably mounted on the first rail and the second rail and a second retention mount is connected to the second carriage. In addition, the additive manufacturing machine includes a transfer film connected to the first retention mount and to the second retention mount, and a load cell connected to the first carriage and the second carriage, wherein the load cell is configured to monitor tension in the transfer film.

### FIELD

The present disclosure relates to a system and method for transfer film management in additive manufacturing.

### BACKGROUND

Additive manufacturing is a process of forming parts by depositing one or more materials layer by layer, “building up” a component. The process generally utilizes digital computer models, such as a computer-aided designs or digital 3D models, sliced into layers, to control the selective deposition, melting, curing, and/or binding of material. Additive manufacturing accommodates complex geometries without the need for molds or dies. There are a number of additive manufacturing techniques that can be used for the formation of parts from liquid resin materials. For example, stereolithography (SLA) printing uses laser light to cure liquid resin stored in a vat by tracing the layer geometry with the laser. Digital light processing (DLP) uses light projected onto a vat to cure an entire layer of liquid resin all at once.

However, the processes noted above use resin precursors, exhibiting viscosities of less than 10,000 centipoise at room temperature (20 degrees Celsius). These resins may lead to poor mechanical properties due to the composition of the precursors. As a result, the parts obtained are not always suitable for end-use and industrial applications. These applications include but are not limited to seals, structural brackets, automotive components such as under-the-hood parts and electrical connectors, footwear components including outer soles and orthoses, healthcare applications such as hearing aid components and medical devices, and battery components.

There are many challenges in manufacturing components formed from relatively high viscosity precursors, including material processibility due to the higher viscosity, the formation of voids, and poor layering. While extrusion and casting have been used in forming viscous polymers, geometries formed using these methods are limited. In addition, extrusion dies and molds are usually necessary for forming these materials.

Accordingly, room remains for improvement of additive manufacturing systems and methods for improved manufacturing resins having viscosities of 20,000 centipoise or greater.

### SUMMARY

According to embodiments, the present disclosure relates to an additive manufacturing machine. The additive manufacturing machine includes a process chamber, a first platform mounted on top of the process chamber, a first rail mounted to the first platform and a second rail mounted to the first platform parallel to the first rail. The additive manufacturing machine further includes a first carriage movably mounted on the first rail and the second rail and a first retention mount connected to the first carriage. The additive manufacturing machine also includes a second carriage movably mounted on the first rail and the second rail and a second retention mount connected to the second carriage. In addition, the additive manufacturing machine includes a transfer film connected to the first retention mount and to the second retention mount, and a load cell connected to the first carriage and the second carriage, wherein the load cell is configured to monitor tension in the transfer film.

In embodiments of the above, the additive manufacturing machine further includes a first tension roller mounted on a third carriage, a first set of adjustable tension struts moveably connected to the third carriage, a second tension roller mounted on a fourth carriage, and a second set of adjustable tension struts movably connected to the fourth carriage. The additive manufacturing machine also includes a first idle roller and a second idle roller mounted underneath the first platform, and a linear tension adjustment drive connected to the first and second set of adjustable tension struts, wherein a first end of the transfer film is connected to the first retention mount, wraps around the first tension roller, the first idle roller, the second idle roller, the second tension roller, and a second end of the transfer film is connected to the second retention mount.

In embodiments of the above, the additive manufacturing machine further includes a light engine, wherein the light engine is positioned between the first idle roller and second idle roller, and the light engine includes an optically transparent surface. In further embodiments, the optically transparent surface includes glass exhibiting a thickness of 8 millimeters to 20 millimeters. In additional embodiments, the optically transparent surface is located in the process chamber, and the additive manufacturing machine further comprises a print bed including a support surface provided in the process chamber, wherein the print bed is movable in a first axis towards and away from the optically transparent surface. In further embodiments, the additive manufacturing machine further includes a plurality of linear actuators for adjusting a distance of the print bed from the optically transparent surface, wherein each linear actuator is separately adjustable and the print bed 104 is angle-able relative to the optically transparent surface.

In embodiments of the above, the additive manufacturing machine includes a first side bracket connected to the first platform and a second side bracket connected to the first platform parallel to the first bracket, a first eccentric roller mounted to and extending between the first side bracket and the second side bracket, a first groove extending from the first side bracket and a second groove extending from the second side bracket, a first pusher bar including a first tongue extending from a first end of the first pusher bar slidably mounted in the first groove and a second tongue extending from a second end of the first pusher bar slidably mounted in the second groove, and a spring connected to the first pusher bar, wherein the spring is configured to retain the first pusher bar against the first eccentric roller. In further embodiments, the additive manufacturing machine includes a spatula, wherein the spatula is positioned between a first idle roller and the light engine and wherein in a second position, the pusher bar pushes the transfer film away from a base of the light engine to contact the spatula.

In any of the above embodiments, the transfer film includes silicone.

According to various additional embodiments, the present disclosure relates to a method for printing with an additive manufacturing machine. The method includes transferring a polymer precursor onto a transfer film, moving the polymer precursor on the transfer film under a base of a light engine, raising a print bed towards the transfer film and light engine, contacting the polymer precursor with at least one of a support surface and a previously transferred layer if present, emitting light onto the polymer precursor to at least partially cure the polymer precursor, transferring the at least partially cured polymer precursor onto the at least one of the support surface and the previously printed layer, and maintaining a desired tension on the transfer film by monitoring tension with a load cell connected to the transfer film and adjusting the tension on the transfer film.

In embodiments of the above, the method includes using an additive manufacturing machine that includes a process chamber, wherein a base of the light engine is located in the process chamber, a first platform mounted on top of the process chamber, a first rail mounted to the first platform and a second rail mounted to the first platform parallel to the first rail, a first carriage movably mounted on the first rail and the second rail, a first retention mount connected to the first carriage and a first end of the transfer film, a second carriage movably mounted on the first rail and the second rail, and a second retention mount connected to the second carriage and a second end of the transfer film, wherein moving the polymer precursor on the transfer film includes moving the transfer film by moving the first carriage and second carriage.

In further embodiments, the additive manufacturing machine further also a first tension roller mounted on a third carriage, a first set of adjustable tension struts moveably connected to the third carriage, a second tension roller mounted on a fourth carriage, a second set of adjustable tension struts movably connected to the fourth carriage, and a linear tension adjustment drive connected to the first and second set of adjustable tension struts, wherein a first end of the transfer film is connected to the first retention mount, wraps around the first tension roller, a first idle roller, a second idle roller, the second tension roller, and a second end of the transfer film is connected to the second retention mount, and the method further comprises: adjusting film tension by adjusting an angle between the first set of adjustable tension struts and the second set of adjustable tension struts.

In embodiments of the above, the method includes adjusting the angle between the first set of adjustable tension struts and the second set of adjustable tension struts by activating the linear tension adjustment drive.

In further embodiments of the above, if the tension detected is decreasing from a desired film tension, the angle between the tension struts is increased, and if the tension detected are increasing from the desired film tension, the angle between the tension struts is decreased.

In embodiments of the above, the method includes adjusting film tension by increasing an angle between tensioning struts based on the tension detected by the load cell while peeling the at least partially cured polymer precursor from the transfer film while transferring the at least partially cured polymer precursor onto the at least one of the support surface and the previously printed layer, wherein the desired tension is a peeling target value and if the forces detected are decreasing from the peeling target value, the angle between the tension struts is increased, and if the forces detected are increasing from the peeling target value, the angle between the tension struts is decreased.

In further embodiments, the method includes tilting the print bed while peeling the at least partially cured polymer precursor from the transfer film.

In any of the above embodiments, the method further includes tilting the print bed while raising the print bed towards the transfer film and light engine.

In any of the above embodiments, the method further includes removing excess polymer precursor from the transfer film after transferring the at least partially cured polymer precursor onto the at least one of the support surface and the previously printed layer.

In any of the above embodiments, the method further includes calibrating the height of the print bed prior to transferring a polymer precursor onto the transfer film.

In further embodiments, the additive manufacturing machine includes a linear adjustment drive and calibrating the height of the print bed includes altering the height of the print bed by activating a motor associated with the linear adjustment drive, determining when the motor is running, determining an encoder associated with the motor does not register movement and determining an encoder error, and zeroing out the encoder when the encoder error surpasses a threshold.

### BRIEF DESCRIPTION OF THE DRAWINGS

The drawings described herein are for illustration purposes only and are not intended to limit the scope of the present disclosure in any way.

FIG. 1 illustrates a front view of an additive manufacturing machine according to embodiments of the present disclosure.

FIG. 2 illustrates a print bed, support surface, and light engine according to embodiments of the present disclosure.

FIG. 3 illustrates tilted print bed and support surface, according to embodiments of the present disclosure.

FIG. 4 illustrates a perspective view of the top of the upper portion of the transfer film management system, according to embodiments of the present disclosure.

FIG. 5 illustrates a perspective view of the bottom of the upper portion of the transfer film management system according to embodiments of the present disclosure.

FIG. 6 illustrates a load cell, according to embodiments of the present disclosure.

FIG. 7 illustrates a perspective view of the idle rollers and pusher systems, according to embodiments of the present disclosure.

FIG. 8 illustrates a perspective view of a pusher system, according to embodiments of the present disclosure.

FIG. 9 illustrates a perspective view of a pusher bar, according to embodiments of the present disclosure.

FIG. 10 illustrates a close-up view of the pusher assembly without the pusher bar, according to embodiments of the present disclosure.

FIG. 11 illustrates a perspective view of a light engine according to embodiments of the present disclosure.

FIG. 12 illustrates a cross-sectional view of a light engine, according to embodiments of the present disclosure.

FIG. 13 illustrates a method, according to embodiments of the present disclosure.

FIG. 14 illustrates a system, according to embodiments of the present disclosure.

FIG. 15 illustrates a method according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to an additive manufacturing machine and process, and, in particular, to a system and method for transfer film management in an additive manufacturing process. The system and process may be used with photopolymer precursors that exhibit pre-cursor viscosities of 20,000 centipoise or greater. However, while the system and method are described for use with photopolymer precursors exhibiting a photopolymer pre-cursor viscosity of 20,000 centipoise or greater, the system and method may be used with photopolymer precursors exhibiting a pre-cursor viscosity of less than 20,000 centipoise. In addition, while the systems and methods described herein may be used to make seals, structural brackets, automotive components such as under-the-hood parts and electrical connectors, footwear components including outer soles and orthoses, healthcare applications such as hearing aid components and medical devices, and battery components, other printed components may be formed using the system and methods described herein.

The photopolymer polymer precursors exhibit a viscosity of 10,000 centipoise or greater, such as in the range of 1 centipoise to 5,000,000 centipoise, including all values and ranges therein such as in the range of 20,000 centipoise to 100,000 centipoise. Light, exhibiting one or more wavelengths in the range of 250 nanometers to 750 nanometers, including all values and ranges therein, is used to polymerize the precursors. In embodiments, the photopolymer precursors are cured using light exhibiting one or more wavelengths in the range of 320 nanometers to 435 nanometers, including all values and ranges therein. In embodiments, the polymer precursors include at least one of a monomer and an oligomer, at least one photoinitator, and, optionally, one or more fillers and additives.

The monomers and oligomers include, but are not limited to, one or more of the following: acrylate, methacrylate, vinyl, thiol, epoxy, oxetane, hydroxy, and hydride functional liquid silicones, liquid polyurethanes, urethane monomers, rubbers, and polybutadienes. In further embodiments, the monomers and oligomers include methacrylates and acrylates functional groups on linear, branched, star, or comb urethane, silicone, or polyolefin (polypropylene, polyethylene) backbones. The photoinitators, in embodiments, include at least one of a type I photoinitators such as hydroxyacetophenone (HAP) and phosphineoxide such as diphenyl(2,4,6-trimethylbenzoyl)phosphine oxide (TPO), ethyl (2,4,6-trimethylbenzoyl) phenylphosphinate (TPO-L), phenylbis(2,4,6-trimethylbenzoyl)phosphine oxide (BAPO)), and a type II photoinitiator such as Benzophenone and benzophenone-type photoinitiators, which also require the use of a co-initiator such as an alcohol, amine, thiol or otherwise. The photoinitators (and co-initiators, if present) are present in the range of 0.01 percent by weight to 5 percent by weight, including all values and ranges therein.

The fillers include, but are not limited to one or more of the following: ceramics including silica, alumina, zirconia, ferrites, barium titanate, silicon carbide, silicon nitride, boron carbide, hydroxyapatite, aluminum trihydrate, zinc oxide, and combinations thereof; metals including but not limited to one or more transition metals, which are understood as metals that include valence electrons in two shells instead of only one; and metal alloys, which are understood to include one or more metals or one or more metals with one or more non-metallic elements. Other additives may be added including plasticizers such as dioctyl adipate, diisooctyl phthalate; and additional fillers such as silica in non-ceramic based formulations, glass, and organic materials such as rosin, amine, amide, poly amide, polyurethane, urethane, melamine, phosphinate etc. The fillers are inclusive of all morphology including but not limited to spheres, fibres, flakes, tubes, milled, ground, natural, and cubes. The fillers may be present in the range of 0.1 percent by weight to 90 percent by weight of the total weight of the polymer precursor, including all values and ranges therein such as 0.1 percent by weight to 10 percent by weight, 10 percent by weight to 25 percent by weight, etc. The polymer precursors including fillers may exhibit a viscosity in the range of 20,000 to 5,000,000 centipoise at room temperature (23 degrees Celsius), including all values and ranges therein.

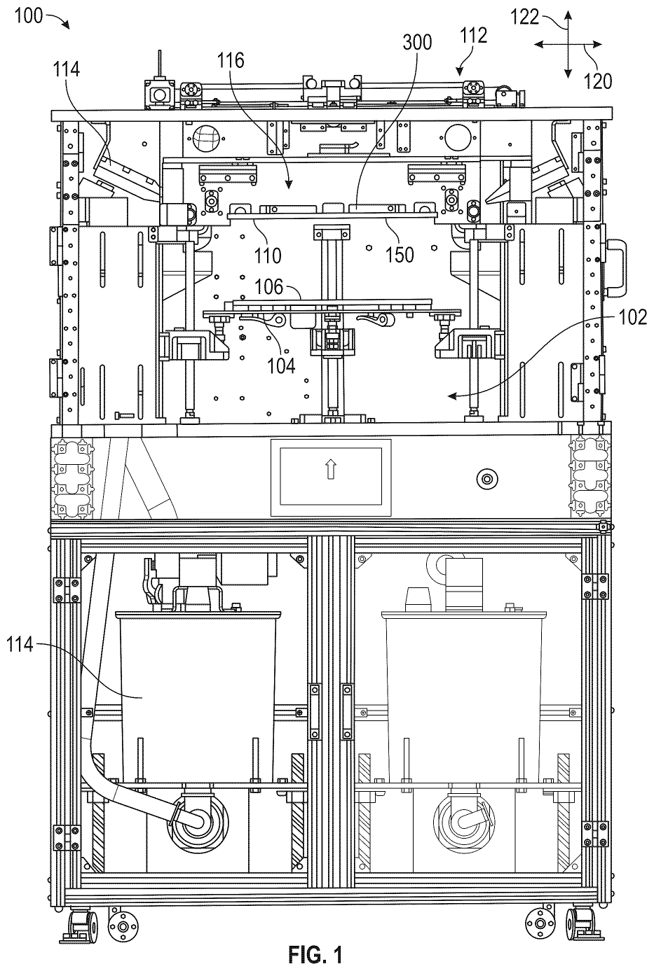

FIG. 1 illustrates an additive manufacturing machine 100 for forming components using, but not limited to, the polymer precursors described above. The additive manufacturing machine 100 defines a process chamber 102. In some embodiments, the temperature and the humidity are controlled within the process chamber 102. Within the process chamber 102 is a print bed 104 including a support surface 106 on which a component is printed. The additive manufacturing machine 100 further includes a transfer film 110 and a transfer film management system 112 for moving the transfer film 110 back and forth between a material feed system 114 and a light engine 116 over the print bed 104. The transfer film 110 is selected based on physiochemical properties between the transfer film 110 and the polymer precursor that define the peeling force per unit area to release an at least partially cured layer of polymer precursor from the transfer film. In embodiments, the transfer film 110 includes a silicone coating or is formed from silicone, which may assist in reducing peeling force, the force required to remove a printed layer 140ₙ₊₁ from the transfer film 110 after exposing the polymer precursor to light. the. Further, the transfer film 110 must be optically transparent to the light emitted from the light engine 116. In being optically transparent, the transfer film 110 allows at least 75 percent of the light emitted from the light engine 116 to pass through the transfer film 110. In embodiments, the transfer film 110 also exhibits a low degree of light scattering through the transfer film 110.

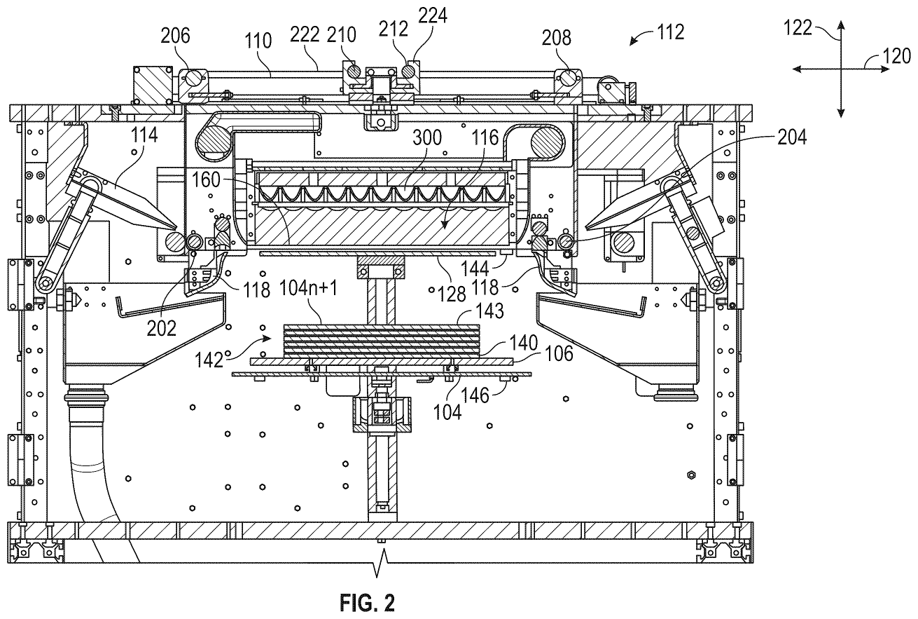

In operation, as illustrated in FIG. 2, a layer 128 of the polymer precursor is dispensed by the material feed system 114 onto the transfer film 110, and specifically to the underside of the transfer film 110 facing the support surface 106 as the transfer film 110 is moved from the material feed system 114 to the light engine 116. The layer 128 of the polymer precursor is positioned over the support surface 106 of the print bed 104 and under the light engine 116. The support surface 106 is then raised in a second axis 122, the “z-direction”, toward the transfer film 110 and contacts the polymer precursor. In addition, force is applied through the transfer film 110 to the light engine 116. The light engine 116 includes an optically transparent surface 160, such as glass or ceramic, that exhibits little to no deflection upon contact of the support surface 106 to the transfer film 110 and the transparent surface 160. In embodiments, the optically transparent surface 160 is glass exhibiting a thickness of 8 millimeters or higher, such as in the range of 8 millimeters to 20 millimeters, including all values and ranges therein. This allows compression of the polymer precursor between the support surface 106 and transfer film 110. In being optically transparent, the optically transparent surface 160 allows at least 75 percent of the light emitted from the light engine 116 to pass through the optically transparent surface 160. In embodiments, the optically transparent surface 160 also exhibits a low degree of light scattering through the optically transparent surface 160. The light source 300 in the light engine 116 is activated and light is emitted and projected through the transfer film 110 onto the polymer precursor at a sufficient dosage and in specific locations to at least partially cure or solidify the polymer precursor to form the next component layer. If previous layers of the component are present, the polymer precursor may also bind to the previously printed layers. The at least partially cured polymer precursor is transferred to the support surface 106 of the print bed 104 and the print bed 104 is lowered along the second axis 122. After the at least partially cured polymer precursor is deposited onto the print bed 104 by transferring the at least partially cured layer on the print bed 104, and excess photopolymer precursor the transfer film 110 is removed from the transfer film 110 by one or more spatulas 118 and the process is repeated. As illustrated, a first spatula 118 is located between first idle roller 202 and the base 150 (see FIG. 1) of the light engine 116 and a second spatula 118 is located between the second idle roller 204 and the base 150 (see FIG. 1) of the light engine 116. It should be appreciated that only one, or more than two spatulas 118 may be provided. In embodiments, the spatulas 118 are rotatable or shiftable to contact the transfer film 110 once the layer being printed has been transferred to the component 142 or support surface 106 to remove excess precursor from the transfer film 110.

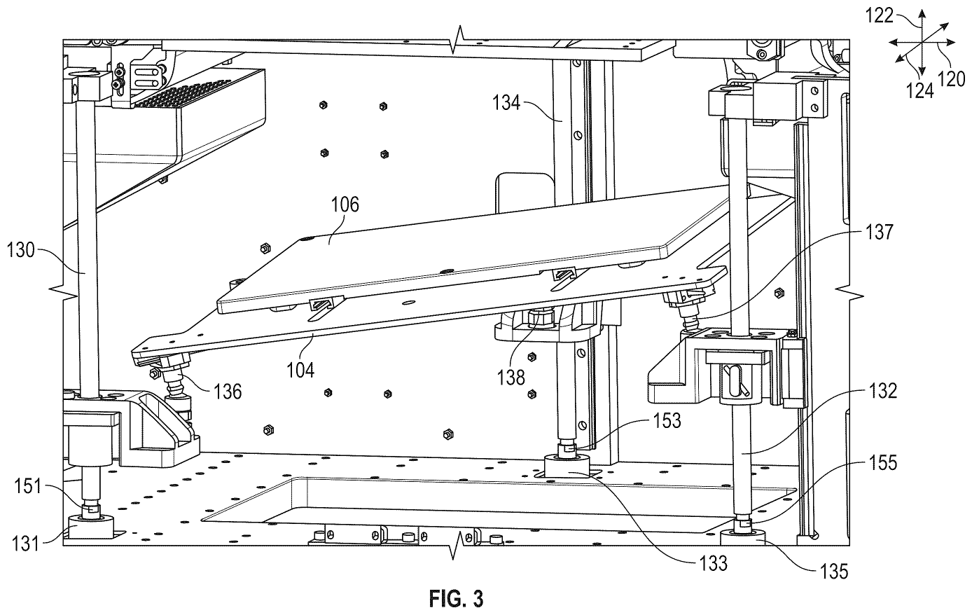

Turning now to FIG. 3, with further reference to FIG. 1, the print bed 104 is coupled to at least three linear actuators 130, 132, 134 for moving the print bed 104 up and down in the second axis 122, i.e., the z-direction. In alternative embodiments, one, two, four or more linear actuators may be provided. The linear actuators 130, 132, 134 may each include, for example, a threaded spindle and ball screw drive, roller screw drive, linear motor, etc. The print bed 104 is connected to the linear actuators 130, 132, 134 using ball joints 136, 137, 138 allowing the print bed 104 to move in an angular direction. Movement of the linear actuators 130, 132, 134 at the same rate allows for the print bed 104 to maintain parallelism with the base 150 of the light engine 116 as it is raised and lowered along the z-axis 122.

Each linear actuator 130, 132, 134 may also be separately adjusted so that the print bed 104 may be angled at various angles from the plane defined by the optically transparent surface 160 of the light engine 116, or from a plane defined by the first axis 120 and third axis 124 up to 20 degrees in any given direction. Angling the print bed 104 while raising the support surface 106 up to the transfer film 110 may assist in reducing void formation between the at least partially cured polymer precursor being transferred and the previously transferred layer 140n+1 or the support surface 106, itself. Angling of the print bed 104 and support surface 106 may also be used to assist in peeling the at least partially cured polymer precursor being transferred from the transfer film 110 as described further herein.

Further, the print bed 104 is calibrated parallel to a reference surface, such as the base 150 and optically transparent surface 160 of the light engine 116, by a set of non-contact sensors, such as sensor 144 illustrated in FIG. 2. While only one sensor 144 is shown for clarity more than one sensor, such as two or more sensors, between two and six sensors may be provided, including all values and ranges therein. In embodiments, the print bed 104 and support surface 106 are calibrated in the Z-axis, axis 122 by reading the error from the encoders 151, 153, 155 used in the motors 131, 133, 135 driving the linear actuators 130. In addition, or in alternative embodiments, three sensors are provided and allow for sufficient calibration of the support surface 106. In further embodiments, each sensor is proximal to a linear actuator 130, 132, 134 at the two outer, forward corners of the print bed 104 and one at the center rear of the print bed 104. In addition, in embodiments, the non-contact sensors are at least one of inductive, capacitive, magneto-inductive, magnetic proximity, and inductive proximity. In alternative embodiments, the non-contact sensors are light sensors, including emitters, detectors, and in some embodiments, reflectors.

The print bed 104 includes corresponding magnets 146 or other ferromagnetic elements, or in the case of light sensors, corresponding elements to the elements mounted to the base 150 of the light engine 116 such as detectors, reflectors or emitters. The magnets 146 or other elements are mounted to correspond to each sensor. As may be appreciated, if light sensors are used, the light emitted and detected by the light sensors include wavelengths that do not trigger photopolymerization of the polymer precursor and the light engine 116 does not emit light at wavelengths detected by the light sensors.

Supported on the print bed 104 is a support surface 106 on which the various layers 140, 140n+1 of the component 142 are transferred (see FIG. 2). The support surface 106 is, in embodiments, removably mounted onto the print bed 104 to facilitate removal of printed components from the print bed 104 as well as to allow for the use of different support surface 106 materials based on the polymer precursor. In addition, while the support surface 106 is illustrated as being relatively flat and rectangular, the support surface 106 may exhibit other geometries and have a relatively circular or oblong surface or exhibit a relatively curvate shape in the z-axis. Further, the support surface 106 may exhibit various surface finishes and textures to prevent slippage of the component during printing, facilitate release of the printed component, or both prevent slippage of the component during printing and facilitate release of the printed component. Additionally, the support surface 106 may exhibit various coatings to prevent slippage of the component during printing, facilitate release of the printed component, or both prevent slippage of the component during printing and facilitate release of the printed component. In yet further embodiments, the support surface 106 may include a flexible release surface on which the component 142 is printed. The flexible release surface may be held onto the support surface by one or more of mechanical and magnetic means.

Either the print bed 104 or the support surface 106 may include additional sensors. Such sensors may include force sensors, such as load cells, piezoelectric sensors, or pressure sensors. These sensors may be used to detect the peeling forces during printing. The print bed 104 or support surface 106 may also include a temperature sensor for measuring the temperature of at least one of the print bed 104 and the support surface 106.

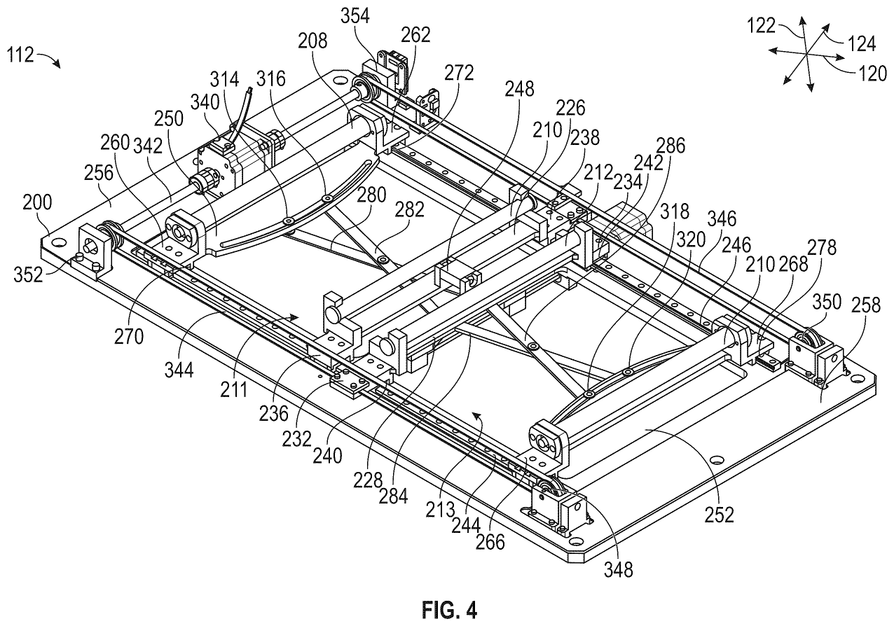

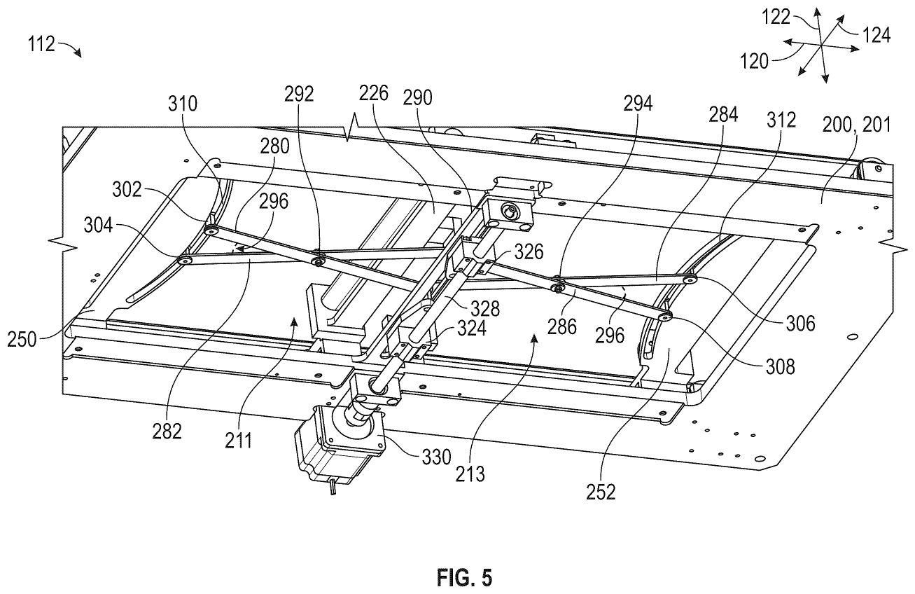

As noted above and referring again to FIG. 1, the transfer film 110 is moved back and forth between the material feed system 114, the light engine 116, and the spatulas 118 by a transfer film management system 112. FIGS. 4 and 5 illustrate an embodiment of the transfer film management system 112. The transfer film management system 112 includes a first platform 200 mounted on top of the process chamber, idle rollers 202, 204 (see FIG. 2), tension rollers 206, 208, and retention mounts 210, 212. Openings 211, 213 in the first platform 200 accommodate the movement of the transfer film 110 between the idle rollers 202, 204 and the tension rollers 206, 208. In embodiments, the first platform 200 defines a side of the process chamber.

With reference to FIG. 2, the idle rollers 202, 204 space the transfer film 110 from the base 150 of the light engine 116 in the second axis 122 in the process chamber 102, so that the transfer film 110 touches and slides across the base 150 of the light engine 116 reducing the stress that may be incurred if the transfer film 110 passed over the corners of the light engine 116 on either side of the base 150. As illustrated, the light engine 116 is positioned between the idle rollers 202, 204. In some embodiments, the idle rollers 202, 204 rotate with the transfer film 110 as the transfer film 110 is shuttled back and forth relative to the material feed system 114 and the light engine 116. The idle rollers 202, 204 are supported at either end of each roller in a rotating manner by a first side bracket 214 and a second side bracket 216. The first side bracket 214 and the second side bracket 216 are connected to and extend from the base 201 (see FIG. 5) of the first platform 200. The transfer film 110 is also supported by the tension rollers 206, 208, which in some embodiments may rotate with the transfer film 110 as it passes over the tension rollers 206, 208.

The transfer film 110 is secured at each end 222, 224 to the retention mounts 210, 212, which in the illustrated embodiment are rollers. The first retention mount 210 is secured on a first carriage 226 and the second retention mount 212 is secured to a second carriage 228. In embodiments, the retention mounts 210, 212 are retained in a non-rotating manner on the first carriage 226 and second carriage 228. The first carriage 226 and the second carriage 228 span the first platform 200 in a third axis 124. The first carriage 226 and the second carriage 228 are each secured to the first platform 200 by two carriage brackets 232, 234, 236, 238 one on either side of each carriage 226, 228. The carriage brackets 232, 234, 236, 238 each include a channel 240, 242 (illustrated only load on the second carriage 228 for clarity) defined in the underside of the carriage brackets 232, 234, 236, 238. A first rail 244 and a second rail 246 parallel to the first rail 244, are secured to each side of the first platform 200 and the rails 244, 246 are received in each channel 240, 242 and the carriage brackets 232, 234, 236, 238 slide over the rails 244, 246 in the first axis 120.

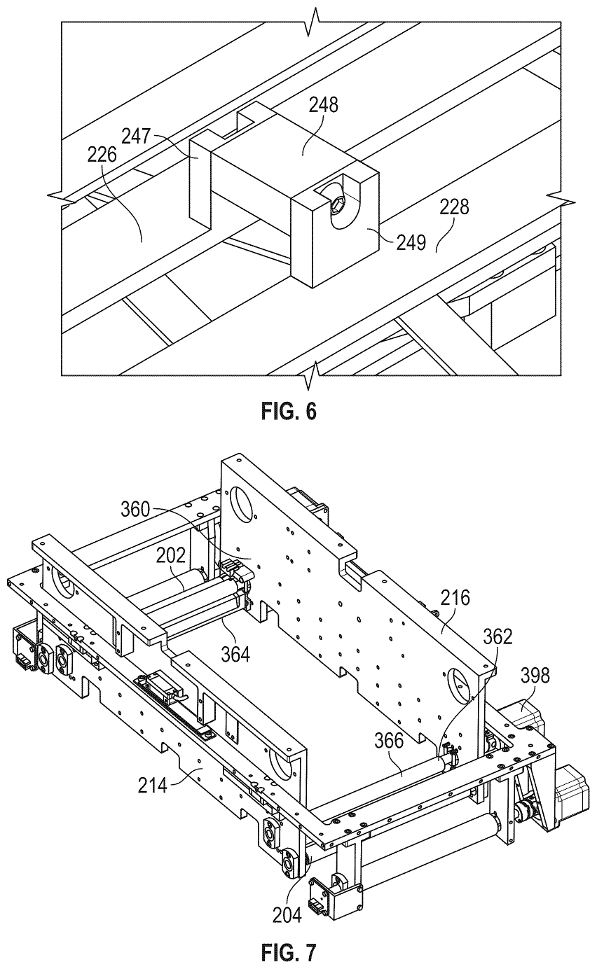

In addition, the first carriage 226 and the second carriage 228 are coupled together with a load cell 148 as illustrated in FIG. 6. In the illustrated embodiment, the carriages 226, 228 are coupled to the load cell 148 with load cell brackets 247, 249 near the center of the carriages 226, 228; however, in alternative embodiments, the carriages 226, 228 are coupled together at both ends or at one end of the carriages 226, 228 proximal to the carriage brackets 232, 234, 236, 238. The load cell brackets 247, 249 may be formed integrally with the carriages 226, 228 or may be connected to the carriages 226, 228. The load cell 148 measures tension between the first carriage 226 and the second carriage 228 to provide closed-loop control over the transfer film 110 tension and dynamically adjust the tension of the transfer film 110 during the printing using the tensioning brackets further discussed with reference to FIG. 5. The output from the load cell 148 is used in as an input in one or more algorithms to adjust the tensioning brackets and activate the motor associated with the tensioning brackets. In addition, the load cell 149 may be used to detect and measure peeling forces to indicate whether the at least partially cured polymer precursor being transferred has released from the transfer film 110 and speed up the printing process, whether the support surface 106 is sufficiently in contact with and applying force to the layer 128 of the uncured polymer precursor, whether there is residual polymer precursor on the transfer film 110 that could interfere with printing, and identify other errors or deviations during a print job.

The first tension roller 206 is supported by a third carriage 250 and the second tension roller 208 is supported by a fourth carriage 252 that each span the first platform 200. The tension rollers 206, 208 are located proximally to the ends 256, 258 of the first platform 200 and the retention mounts 210, 212 are located inward of the tension rollers 206, 208. The third carriage 250 and fourth carriage 252 each include a carriage bracket 260, 262, 266, 268 on either side of the carriages 250, 252. Each carriage bracket 260, 262, 266, 268 includes a channel 270, 272, 276 (not illustrated), 278 for receiving the first rail 244 and the second rail 246. The carriage brackets 260, 262, 266, 268 move back and forth on the rails 244, 246 along the first axis 120. The tension rollers 206, 208 are each spaced from the retention mounts 210, 212 by a pair of adjustable tensioning brackets 280, 282, 284, 286.

With reference to FIG. 5, which illustrates the underside of the transfer film management system 112 and the first platform 200, the first pair of adjustable tensioning struts 280, 282 are adjustably secured between the third carriage 250 and a bridge 290. The bridge 290 is connected at either end to the support platform 200. The second pair of adjustable tensioning struts 284, 286 are adjustably secured between the fourth carriage 252 and the bridge 290. Each pair of adjustable tensioning struts 280, 282, 284, 286 are also secured together at or near the center 292, 294 of the struts 280, 282, 284, 286 in a rotatable manner similar to a scissor, so that the ends of the tension struts 280, 282, 284, 286 may be brought together and secured in place to make the distance between the carriages 226, 250, 228 252 farther apart, or so that the ends of the tension struts 280, 282, 284, 286 may be spread apart and secured in place to make the distance between the carriages 226, 250, 228 252 closer together.

The ends of tensioning struts 280, 282, 284, 286, secured to the third carriage 250 and fourth carriage 252, include a pin 302, 304, 306, 308 that extends into an arcuate open channel 310, 312 defined in the third carriage 2502 and fourth carriage 252. The pins 302, 304, 306, 308 include a pin head 314, 316, 318, 320 having a diameter greater than the width of the opening of the arcuate open channels 310, 312 (see FIG. 4). Two of the ends of the tensioning struts 280, 284, opposing the third carriage 250 and fourth carriage 252, are rotatably coupled to a first tensioning carriage 324 and two ends of the tensioning struts 282, 286, also opposing the third carriage 250 and fourth carriage 252, are rotatably coupled to a second tensioning carriage 326. The tensioning carriages 324, 326 are secured to a linear tension adjustment drive 328, such as a ball screw having a dual threaded spindle. The linear tension adjustment drive 328 is configured to move the tensioning carriages 324, 326 toward each other or away from each other depending on the rotation imparted by the tensioning motor 330 on the linear adjustment drive 328 and adjusting the angle 296 between the tensioning struts 280, 282, 284, 286. Alternatively to a ball screw, two hydraulic or mechanical linear actuators may be coupled to the tensioning carriages 324, 326.

In operation, the transfer film 110 is secured at a first end to the first retention mount 210, is wrapped around the first tension roller 206, through the first opening 211, around the first idle roller 202, adjacent to the base 150 of the light engine 116, around the second idle roller 204, up through the second opening 213, around the second tension roller 208 and is secured to the second retention mount 210. In this manner, the transfer film exhibits a trapezoidal, or “C” shape. A motor 340 is coupled to a shaft 342, which drives the second carriage 228 back and forth by a set of pulleys 344, 346. At one end 256 of the first platform 200, a first pulley 344 is coupled to a first end of the shaft 342 and a second pulley 346 is coupled to a second end of the shaft 342, opposing the first end. The pulleys 344, 346 are supported by either a second shaft or rotatably mounted wheels 348, 350, as illustrated, at the opposing end 258 of the first platform 200. The shaft 342 is rotatably supported proximally to the first end 256 of first platform 200 by another set of brackets 352, 354. The carriage brackets 232, 234 mounting to the second carriage 228 to the rails 244, 246 are also connected to the set of pulleys 344, 346, so that the movement of the pulleys 344, 346 along the first axis 120 translates into movement of the second carriage 228 along with the first carriage 226, being connected to the second carriage 228, in the direction of and along the first axis 120.

In alternative embodiments, the ends 222, 224 of the transfer film 110 are not connected to the retention mounts 210, 212 but are connected together and the transfer film 110 rotates completely around, rather being shuttled back and forth. In such an embodiment, the pulleys 344, 346 are coupled to at least one of the tension rollers 206, 208 or at least one of the retention mounts 210, 212 to drive the roller(s). In further embodiments, one or more of the driven rollers, i.e., the tension rollers 206, 208 or the retention mounts 210, 212, include a sprocket or other device that engages with the transfer film 110 and rotates the transfer film 110 in complete circles.

The transfer film management system 112 also includes at least one pusher system 360 for pushing on the transfer film 110 to apply tension on the transfer film 110 or angle the transfer film 110 at a desired angle. As may be appreciated, more than one, such as two pusher systems 360, 362 as illustrated, to four pusher systems, or even more pusher systems, may be present. The pusher systems 360 illustrated in FIG. 7 moves from a first position to a second position to push the transfer film 110 away from the base 150 of the light engine 116 facilitating the peeling of the at least partially cured polymer precursor from the transfer film. The pusher systems 360, 362 may also cause the transfer film 110 to contact the spatulas 118 to remove excess polymer precursor off the transfer film 110 as the transfer film 110 retreats after transferring the at least partially cured polymer precursor. The pusher systems 360, 362 may also be used to tilt the transfer film 110 relative to the support surface 106 as the support surface 106 is being raised upward to receive a new layer of polymer precursor to allow air to flow away from the interface of the already transferred layers 140, 140n+1 and the new layer to avoid voids.

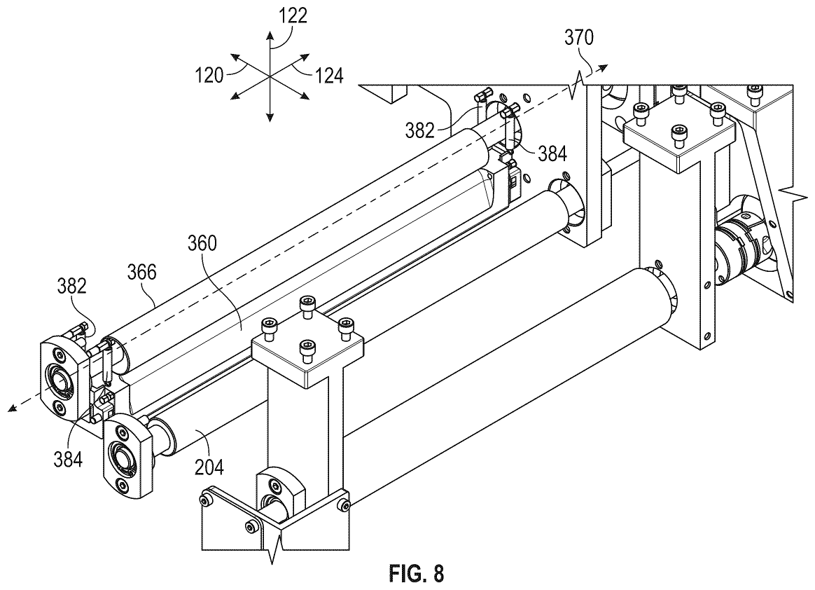

The pusher systems 360, 362 are secured at each side of the pusher systems 360, 362 by the first side bracket 214 and second side bracket 216. As illustrated, the pusher systems 360, 362 are mounted internally of, and generally parallel to, the first and second idle rollers 202, 204, and traverse to the movement of the transfer film 110 so that the transfer film 110 passes under the pusher system 360, 362, and in some embodiments, contacts and slides over the base 364 of the pusher systems 360, 362 in a similar manner to the base 150 of the light engine 116. FIGS. 8, 9, and 10 illustrate the various features of a first pusher system 362; however, this description is equally applicable to the second pusher system 360.

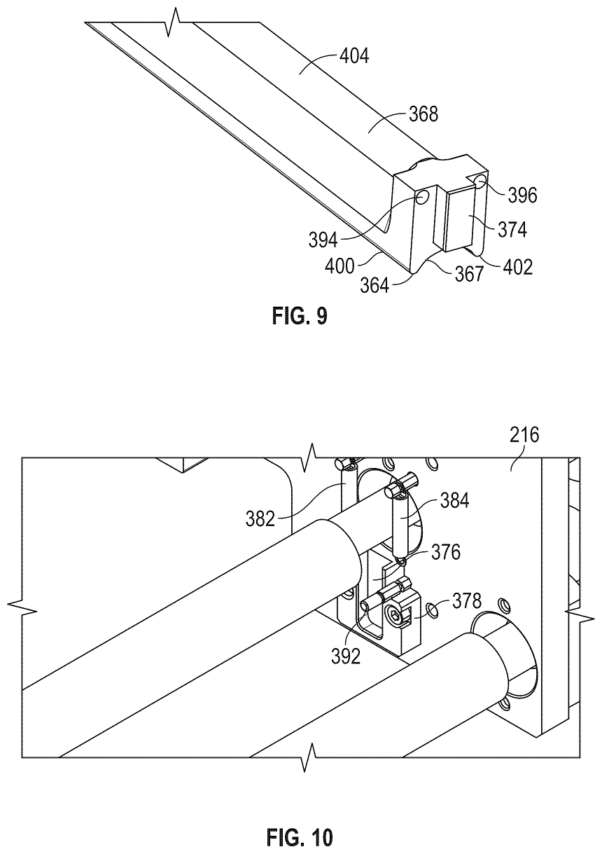

The pusher system 362 generally includes an eccentric roller 366 rotatably mounted in the first side bracket 214 and the second side bracket 216 and a pusher bar 368 mounted to the first side bracket 214 and second side bracket in a slidable manner, wherein the pusher bar 368 slides up and down in the second axis 122 relative to the rotating axis 370 of the cam roller 366. The rotating axis 370 of the cam roller 366 is generally parallel to the third axis 124. Alternatively to using eccentric rollers 366, pneumatic or hydraulic actuators may be used to apply force against the pusher bar 368 or directly against the film. As illustrated in FIG. 9, the pusher bar 368 includes a tongue 374 extending from each end of the pusher bar 368. The tongue 374 is received in a groove 376 defined in a mounting block 378 connected to the side brackets 214, 216 illustrated in FIG. 10. Alternatively, the groove 376 may be defined in the side brackets 214, 216 themselves.

Further, as illustrated, in FIG. 10 a pair of springs 382, 384 are used to retain the pusher bar 368 against the eccentric roller 366 at each end of the pusher bar 368. The springs 382, 384 are connected to pins 386, 388 that are inserted into or otherwise connected to the brackets 216, 216 at a first end and connected to pins 390 (not shown), 392 that are inserted into and retained within openings 394, 396 in the pusher bar 368 at the second end of the springs 382, 384 or otherwise connected to the pusher bar 368.

In operation the pusher bar 368 is pushed down by rotating the eccentric roller 366, or alternative actuator, using a motor 398 attached to the eccentric roller 366 until the apogee of the eccentric roller 366 is contacting the pusher bar 368. At this point, the distance between the surface of the pusher bar 368 contacting the eccentric roller 366 and the rotating axis 370 is at a maximum. The springs 382, 384 then push the pusher bar 368 back up as the eccentric roller 366 continues to rotate and reaches the perigee of the eccentric roller 366. At this point, the distance between the pusher bar 368 contacting the eccentric roller 366 and the rotating axis 370 is at a minimum.

Referring again to FIG. 8, the pusher bar 368 exhibits a curvate geometry at the base 364 and defines a generally concave surface 367. In embodiments, the exterior corners 400, 402 are rounded, reducing stresses applied to the transfer film 110. Further, a portion of the top surface 404 is also rounded forming a convex surface. This reducing the overall weight of the pusher bar 368.

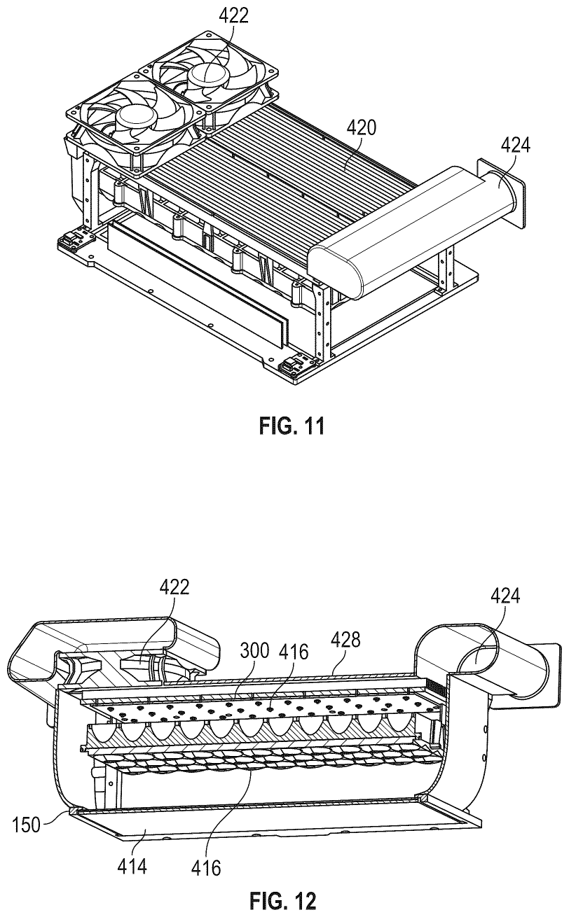

With reference again to FIG. 2, as well as FIGS. 11 and 12 the light engine 116 includes a light source 300. The light source 300 is spaced away from a transparent plate 414, such as a glass plate of a liquid crystal display, through which light emitted from the light source 300 passes. The transparent plate 414 also serves as a support for the transfer film 110, particularly as the print bed 104 is elevated to contact a polymer precursor layer 128. The light source 300 may include, but is not limited to, for example light emitting diodes, a liquid crystal display, and mercury lamps. The light source 300 may include an array of individual light sources 300 as illustrated. Further, in embodiments, a light emitting diode array including one or more elements 416 including at least one of optical elements or refractive elements providing at least one of collimation, a pixilated display, a projector, or a physical mask may be used to make the desired shapes and patterns for each cross section. The light source 300 may exhibit a power density as measured at the surface 143 of the previously transferred layer 140n+1 (see FIG. 2) of 3 milliwatts per centimeter squared to 1000 milliWatts per centimeter squared, including all values and ranges therein, such as 4 milliwatts per centimeter squared to 10 milliWatts per centimeter squared, 100 milliWatts per centimeter squared to 500 milliWatts per centimeter squared. As noted above, the light emitted from the light source 300 exhibits one or more wavelengths in the range of 250 nanometers to 750 nanometers, including all values and ranges therein, such as one or more wavelengths in the range of 250 nanometers to 435 nanometers. In embodiments, cooling fins 420 are present on the upper surface of the light source 300 in the light engine 116. Air is directed from intake fans 422, over glass plate 414 of the liquid crystal display, and through vent 424 by a shroud 428 covering the light engine 116.

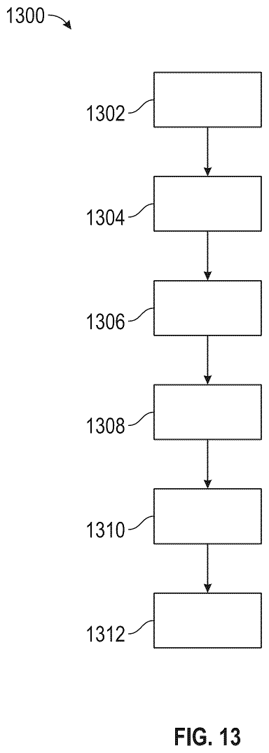

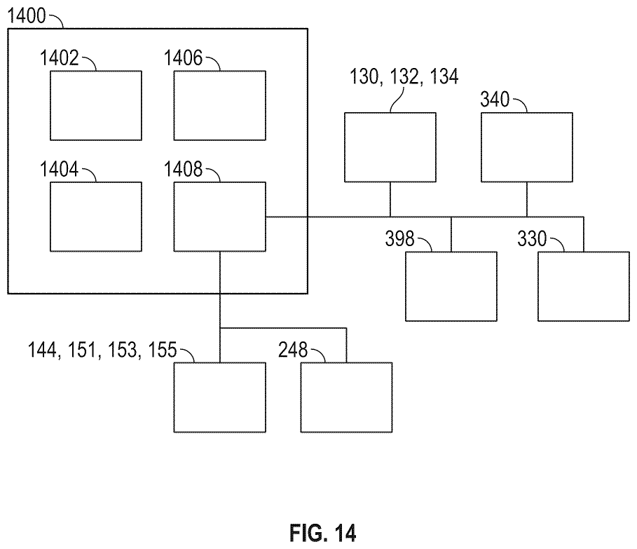

FIG. 13, with further reference to FIGS. 1 through 12, illustrates a general method 1300 of forming a part using the additive manufacturing machine 100. At block 1302 a polymer precursor is deposited onto a transfer film 110. The transfer film 110 is moved towards the light engine 116 as the polymer precursor is being transferred onto the transfer film 110 to form a layer 128 of the polymer precursor on the transfer film 110. At block 1304, the print bed 104 and support surface 106 are raised towards the light engine 116 and the support surface, or a previously printed layer 140n+1, contact the polymer precursor layer 128 on the transfer film 110. At block 1306 the light engine activates a light source 300 within the light engine 116. The light source 300 casts light in a desired pattern onto the polymer precursor layer 128 to at least partially cure the polymer precursor layer 128 and, if a previously printed layer 140n+1 is present bind desired portions of the layer being cured to the previously printed layer 140n+1. At block 1308, the at least partially cured polymer precursor is transferred to the support surface 106 or the previously printed layer 140n+1 as the print bed 104 is lowered. At block 1310, if the at least partially cured polymer precursor has not been fully cured, the at least partially cured polymer precursor is cured when the next layer is printed or cured in a post printing process by applying light to the component. Optionally, at block 1312, a cleaning device may be used to remove uncured polymer precursor from the last deposited layer, now 140n+1, of the component 142. The tension on the transfer film 110 is monitored by a control system, an embodiment of which is illustrated in FIG. 14.

The control system 1400 includes one or more controllers 1400, which includes one or more processors 1402 for executing algorithms and other processes embodied by code stored in at least one of the processor 1402 and tangible, non-transitory memory 1404. In executing such algorithms and processes, the processors 1402 may access data from a number of sensors, including the load cell 248 and the position sensors 144, or encoders 151, 153, 155 used to calibrate the location of the print bed 104 relative to the base 150 of the light engine 116. The data is, in embodiments, stored in the tangible, non-transitory memory 1404. In addition, in executing such algorithms and processes the processors 1402 may drive the motors, such as the motors in the linear actuators 130, 132, 134, the motor pusher motor 398, the transfer film motor 340, and the tensioning motor 330. The controller may also include an input and output devices 1408 configured to receive inputs from the various sensors as well as user inputs and configured to provide outputs to the various motor, fans, light engine, and temperature devices that are present in the machine as well as to provide information to a user regarding system status.

With regard to tensioning of the transfer film 110, the forces detected by the load cell 248 are stored in tangible, non-transitory memory 1404 or accessed directly form the load cell 248 by the processor 1402 in the controller 1400. If, during the printing process, the tension on the transfer film 110 is detected as decreasing, indicating relaxation of the transfer film 110, the controller 1400 increases the film tension by increasing the angle 296 between the tensioning struts 280, 282, 284, 286. Relaxation of the transfer film 110 may potentially be caused by peeling forces, creep of the transfer film 110 itself, or a slipping movement. In embodiments, the tension is maintained at a selected target value stored in the processor 1402 or tangible, non-transitory memory 1404.

Further, in embodiments, while peeling the at least partially cured new layer from the transfer film 110, the tension of the transfer film 110 may be increased or decreased to maintain a peeling target value or range of values stored in the processor 1402 or tangible, non-transitory memory 1404. For example, if the tension is measured by the load cell 248 as being too high and outside of the range, it may be that the tension applied to the transfer film 110 may need to be reduced so that transfer film 110 does not elongate under stress or break. Similarly, if the tension is measured by the load cell 248 as being too low and outside of the range, it may be that the tension applied to the transfer film 110 may need to be increased to facilitate peeling. Additionally, or alternatively, the tension may be used to identify the occurrence of peeling during the process, providing an in-process verification of quality.

In addition to dynamically adjusting transfer film 110 tension, peeling propagation may be assisted with the tilting of the print bed 104 and support surface 106 by adjusting one or more of the linear actuators 130, 132, 134. In embodiments, the linear actuators 130, 132 closest to the opening 162 of the process chamber 102 may be adjusted to drop the front of the print bed 104 down. In alternative embodiments, the linear actuator 134 near the rear of the process chamber 102 may be adjusted to drop the back of the print bed 104 down. The support surface 106, with the print bed 104, drops at an angle of 2 degrees to 15 degrees relative to the transparent surface 160 of the light engine. In embodiments, both the transfer film 110 and the print bed 104 may be tilted, the transfer film 110 with the pusher systems 360, 362 and the print bed 104 using the linear actuators 130, 132, 134. The tilted surfaces locally increase the tension of the film in specific regions of the interface of the film and the at least partially cured polymer precursor being transferred onto the support surface 106. This allows a critical peeling force to be reached at a specific and controlled zone of the print bed 104 and the peeling propagates accordingly. By creating a specific and controlled zone to initiate peeling, process repeatability is increased and potential issues caused by cupping of the at least partially cured polymer precursor being transferred onto the support surface may be reduced. Tilting of the print bed 104 and support surface 106 may also be used to for compressing the polymer precursor while raising the print bed 104 towards the base 150 of the light engine 116. By tilting the support surface 106 with polymer precursor deposited on it, bubbles may be reduced by reducing air entrapment between the previously printed layer and the layer of polymer precursor to be printed. Further, in embodiments, vibrations may be applied to the support surface 106 by the linear actuators 130, 132, 134. The vibrations may be applied sinusoidally and be used to compress the polymer precursor to assist in achieving a desired layer thickness.

The controller 1400 may also determine that peeling is complete using the load cell 248 or force sensors on the print bed 104 or support surface 106. The angle of the print bed 104 may then be readjusted before the print bed 104 is raised to receive the next layer of polymer precursor and dynamically adjusted as the support surface 106 approaches the base 150 of the light engine 116 to reduce voids between the layers. To assist in reducing voids and evacuating the air between the layers, the pusher systems 360, 362 may also be used. The transfer film 110 and print bed 104 may be tilted in a variety of angles to assist in reducing voids and air entrapment between the layers.

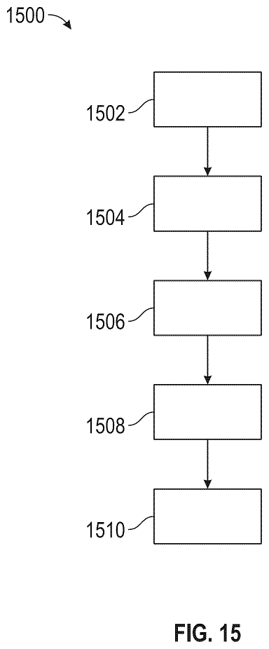

Further, the controller 1400 may be used to calibrate the height of the print bed 104 in the z-axis, axis 122. FIG. 15 illustrates a method 1500 of calibrating the height of the print bed 104. At block 1502 the linear actuators 130, 132, 134 are adjusted, altering the height of the print bed, the linear actuators 130, 132, 134 are adjusted with the motors 131, 133, 135 (respectively) to a mechanical reference or end-stop position, such as the base 150 of the light engine, which may be defined by a liquid crystal display or a glass plate, less than two millimeters in thickness covering the liquid crystal display. Each motor is monitored with its own encoder. At block 1504, the control system 1400 determines a motor 131, 133, 135 has encountered an obstacle, such as when the motor 131, 133, 135 runs but the encoder 151, 153, 155 associated with the motor 131, 133, 135 does not register movement. The encoder error value is increased at block 1506. At block 1508, it is determined that the encoder error value surpasses a predetermined threshold that indicates the linear actuator cannot move any further. At block 1510, the controller defines or records the position of encoder 151, 153, 155 or the encoder value and linear adjustment mechanism are at as zero. This operation may be repeated multiple times, decreasing the measurement re

[symbol]

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 1400 may also consist of multiple controllers which are in electrical communication with each other. The controller 1400 may be inter-connected with additional systems and/or controllers of the additive manufacturing machine 100, allowing the controller 1400 to access data such as, for example, speed, acceleration, temperatures, pressures, and various other process characteristics of the additive manufacturing machine 100.

A processor 1402 may be a custom made or commercially available processor, a central processing unit (CPU), a graphics processing unit (GPU), an auxiliary processor among several processors associated with the controller 1400, a semi composite conductor-based microprocessor (in the form of a microchip or chip set), a macroprocessor, a combination thereof, or generally a device for executing instructions.

The tangible, non-transitory memory 1404 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 1404 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 1400 to control various systems of the additive manufacturing machine 100.

The communication device 1406 includes one or more interface circuits. In some examples, the interface circuits include wired or wireless interfaces that are connected to a local area network (LAN), the Internet, a wide area network (WAN), wireless local area networks (WLAN), cellular networks, or combinations thereof.

The machines and methods herein offer a number of advantages. These advantages include, for example, the ability to control and dynamically adjust transfer film tension, the inclination of the film to a certain angle from the reference printing surface, and the inclination of the build platform to a certain angle from the reference printing surface, allowing for control of the peeling propagation and peeling of a printed layer from the transfer film. These advantages also include, through the use of silicone coated film, a reduction in peeling forces, which may increase productivity and part quality. These advantages further include the ability to compensate for creep and film distortion in the transfer film. These advantages further include the ability to reduce air trapping and void formation during the printing process. These advantages additionally include the ability to improve reliability. These advantages also include improving yield. Further, each film and material exhibit different physicochemical interactions that define the peeling force per unit of area to release a cured layer of material from the transfer film and each print job has a different cross-sectional geometry and surface. As a result, peeling forces widely vary from print job to print job. Thus, a further advantage of the machine and methods of the present disclosure is the ability to implement strategies to control and keep within desired ranges the tension on the film and localization of peeling forces in order to avoid an accelerated film degradation and improve part accuracy.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An additive manufacturing machine, comprising:
a process chamber;
a first platform mounted on top of the process chamber;
a first rail mounted to the first platform and a second rail mounted to the first platform parallel to the first rail;
a first carriage movably mounted on the first rail and the second rail;
a first retention mount connected to the first carriage;
a second carriage movably mounted on the first rail and the second rail;
a second retention mount connected to the second carriage;
a transfer film connected to the first retention mount and to the second retention mount; and
a load cell connected to the first carriage and the second carriage, wherein the load cell is configured to monitor tension in the transfer film.

2. The additive manufacturing machine of claim 1, further comprising:
a first tension roller mounted on a third carriage;
a first set of adjustable tension struts moveably connected to the third carriage;
a second tension roller mounted on a fourth carriage; and
a second set of adjustable tension struts movably connected to the fourth carriage;
a first idle roller and a second idle roller mounted underneath the first platform; and
a linear tension adjustment drive connected to the first and second set of adjustable tension struts;
wherein a first end of the transfer film is connected to the first retention mount, wraps around the first tension roller, the first idle roller, the second idle roller, the second tension roller, and a second end of the transfer film is connected to the second retention mount.

3. The additive manufacturing machine of claim 2, wherein the transfer film includes silicone.

4. The additive manufacturing machine of claim 2, further comprising a light engine, wherein the light engine is positioned between the first idle roller and second idle roller, and the light engine includes an optically transparent surface.

5. The additive manufacturing machine of claim 4, wherein the optically transparent surface includes glass exhibiting a thickness of 8 millimeters to 20 millimeters.

6. The additive manufacturing machine of claim 4, wherein the optically transparent surface is located in the process chamber, and the additive manufacturing machine further comprises a print bed including a support surface is provided in the process chamber, and the print bed is movable in a first axis towards and away from the optically transparent surface.

7. The additive manufacturing machine of claim 6, further comprising a plurality of linear actuators for adjusting a distance of the print bed from the optically transparent surface, wherein each linear actuator is separately adjustable and the print bed 104 is angle-able relative to the optically transparent surface.

8. The additive manufacturing machine of claim 4, further comprising a first side bracket connected to the first platform and a second side bracket connected to the first platform parallel to the first bracket;
a first eccentric roller mounted to and extending between the first side bracket and the second side bracket;
a first groove extending from the first side bracket and a second groove extending from the second side bracket;
a first pusher bar including a first tongue extending from a first end of the first pusher bar slidably mounted in the first groove and a second tongue extending from a second end of the first pusher bar slidably mounted in the second groove; and
a spring connected to the first pusher bar, wherein the spring is configured to retain the first pusher bar against the first eccentric roller.

9. The additive manufacturing machine of claim 8, further comprising a spatula, wherein the spatula is positioned between a first idle roller and the light engine and wherein in a second position, the pusher bar pushes the transfer film away from a base of the light engine to contact the spatula.

10. A method for printing with an additive manufacturing machine comprising:
transferring a polymer precursor onto a transfer film;
moving the polymer precursor on the transfer film under a base of a light engine;
raising a print bed towards the transfer film and light engine;
contacting the polymer precursor with at least one of a support surface and a previously transferred layer if present;
emitting light onto the polymer precursor to at least partially cure the polymer precursor;
transferring the at least partially cured polymer precursor onto the at least one of the support surface and the previously printed layer; and
maintaining a desired tension on the transfer film by monitoring tension with a load cell connected to the transfer film and adjusting the tension on the transfer film.

11. The method of claim 10, wherein the additive manufacturing machine further includes a process chamber, wherein a base of the light engine is located in the process chamber, a first platform mounted on top of the process chamber, a first rail mounted to the first platform and a second rail mounted to the first platform parallel to the first rail, a first carriage movably mounted on the first rail and the second rail, a first retention mount connected to the first carriage and a first end of the transfer film, a second carriage movably mounted on the first rail and the second rail, and a second retention mount connected to the second carriage and a second end of the transfer film,
wherein moving the polymer precursor on the transfer film includes moving the transfer film by moving the first carriage and second carriage.

12. The method of claim 11, wherein the additive manufacturing machine further includes a first tension roller mounted on a third carriage, a first set of adjustable tension struts moveably connected to the third carriage, a second tension roller mounted on a fourth carriage, a second set of adjustable tension struts movably connected to the fourth carriage, and a linear tension adjustment drive connected to the first and second set of adjustable tension struts, wherein a first end of the transfer film is connected to the first retention mount, wraps around the first tension roller, a first idle roller, a second idle roller, the second tension roller, and a second end of the transfer film is connected to the second retention mount, and the method further comprises:
adjusting film tension by adjusting an angle between the first set of adjustable tension struts and the second set of adjustable tension struts.

13. The method of claim 12, further comprising adjusting the angle between the first set of adjustable tension struts and the second set of adjustable tension struts by activating the linear tension adjustment drive.

14. The method of claim 12, wherein if the tension detected is decreasing from a desired film tension, the angle between the tension struts is increased, and if the tension detected are increasing from the desired film tension, the angle between the tension struts is decreased.

15. The method of claim 12, further comprising:
adjusting film tension by increasing an angle between tensioning struts based on the tension detected by the load cell while peeling the at least partially cured polymer precursor from the transfer film while transferring the at least partially cured polymer precursor onto the at least one of the support surface and the previously printed layer,
wherein the desired tension is a peeling target value and if the forces detected are decreasing from the peeling target value, the angle between the tension struts is increased, and if the forces detected are increasing from the peeling target value, the angle between the tension struts is decreased.

16. The method of claim 15, further comprising tilting the print bed while peeling the at least partially cured polymer precursor from the transfer film.

17. The method of claim 10, further comprising tilting the print bed while raising the print bed towards the transfer film and light engine.

18. The method of claim 10, further comprising removing excess polymer precursor from the transfer film after transferring the at least partially cured polymer precursor onto the at least one of the support surface and the previously printed layer.

19. The method of claim 10, further comprising calibrating the height of the print bed prior to transferring a polymer precursor onto the transfer film.

20. The method of claim 19, wherein the additive manufacturing machine includes a linear adjustment drive and calibrating the height of the print bed includes altering the height of the print bed by activating a motor associated with the linear adjustment drive, determining when the motor is running, determining an encoder associated with the motor does not register movement and determining an encoder error, and zeroing out the encoder when the encoder error surpasses a threshold.
